(19) United States
(12) Patent Application Publication
(10) Pub. No.: US 2005/0047724 A1
(43) Pub. Date: Mar. 3, 2005

(54) Micro-optic multiplexer/demultiplexer

(76) Inventor: Mina Farr, Palo Alto, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/924,606

(22) Filed: Aug. 24, 2004

Related U.S. Application Data
(60) Provisional application No. 60/497,937, filed on Aug. 26, 2003.

(51) Int. Cl. G02B 6/26

(52) U.S. Cl. 385/47; 385/36

(57) ABSTRACT

Micro-optic components such as multiplexer/demultiplexers are disclosed. In one example, a micro-optic MUX/DEMUX includes a substrate having upper and lower surfaces, and a reflective coating disposed on a substantial portion of the lower surface. Multiple micro-prisms are disposed on the substrate and are constructed and arranged to receive, as inputs, multiplexed data signals having components of different wavelengths, but to transmit, as outputs, only a selected component of the input multiplexed signal. An I/O micro-prism is configured to receive a multiplexed signal from an optical fiber. In operation, the I/O micro-prism receives a multiplexed optical signal from an optical fiber. This multiplexed optical signal is then passed to the array of succeeding micro-prisms, each micro-prism extracting a corresponding component of the input multiplexed optical signal and transmitting the extracted component, until only a single component remains. The single component is then transmitted by the last micro-prism in the array.

### BACKGROUND OF THE INVENTION

1. Related Applications

This application claims the benefit of U.S. Provisional Patent Application Ser. No. 60/497,937, entitled MICRO-OPTIC MULTIPLEXER/DEMULTIPLEXER, filed Aug. 26, 2003, and incorporated herein in its entirety by this reference.

2. Field of the Invention

The present invention relates generally to the construction and use of micro-optic systems and devices. More particularly, embodiments of the present invention are directed to the construction and use of micro-optic components such as multiplexer/demultiplexers (“MUX/DEMUX”).

3. Related Technology

Voice and data communication networks continue to proliferate due to declining zcosts, increasing performance of computer and networking equipment, and increasing demand for communication bandwidth. Communications networks—including wide area networks (“WANs”) and local area networks (“LANs”)—allow increased productivity and utilization of distributed computers or stations through the sharing of resources, the transfer of voice and data, and the efficient processing of voice, data and related information at various locations. Moreover, as organizations have recognized the economic benefits of using communications networks, network applications such as electronic mail, voice and data transfer, host access, and shared and distributed databases, are increasingly used as a means to increase productivity. This increased demand, together with the growing number of distributed computing resources, has resulted in a rapid expansion of the number of installed networks.

As the demand for communication networks has grown, network technology has developed to the point that many different physical configurations presently exist. Examples include Gigabit Ethernet (“GE” or “GigE”), 10 GigE (or “XGig”), Fiber Distributed Data Interface (“FDDI”), Fibre Channel (“FC”), Synchronous Optical Network (“SONET”) and InfiniBand networks. These networks, and others, typically conform to one of a variety of established standards, or protocols, which set forth rules that govern network access as well as communications between and among the network resources. Typically, such networks utilize different cabling systems, have different characteristic bandwidths and typically transmit data at different speeds, or line rates. Network bandwidth, in particular, has been the driving consideration behind many advancements in the area of high speed communication systems, methods and devices.

For example, the ever-increasing demand for network bandwidth has resulted in the development of technology that increases the amount of data that can be pushed through a single channel on a network. Advancements in modulation techniques, coding algorithms and error correction have greatly increased the rates at which data can be transmitted across networks. For example, it was the case at one time that the highest rate that data could travel across a network was at about one Gigabit per second (“Gbps”). That rate subsequently increased to the point where data could travel across Ethernet and SONET networks at rates as high as 10 Gbps, or faster.

Networks such as those described above are typically implemented as optical networks. Some of the basic elements of an optical network include optical transmitters, such as lasers, optical receivers and detectors, such as photodiodes, and transmission media in the form of optical fibers, also sometimes referred to as optical waveguides. In order to maximize the efficiency and utility of the optical transmission media, it is often useful to combine a plurality of data signals into a single transmitted bit stream. This combination process is typically referred to as multiplexing, or simply “MUX.” As the foregoing suggests, optical multiplexing is advantageous in that it provides for relatively more efficient use of the total communications bandwidth represented by a particular fiber or other transmission medium.

When the multiplexed bit stream reaches a predetermined destination, one or more of the data signals that collectively comprise the multiplexed bit stream can then be extracted for further processing and/or use. This extraction process is typically referred to as demultiplexing, or “DEMUX.” Optical multiplexing and demultiplexing are particularly useful in systems where single mode fibers (“SMF”) are employed, but can be usefully implemented with other transmission media as well.

In view of the foregoing, it would be useful to provide micro-optic devices that implement optical multiplexing and/or demultiplexing by way of, for example, a stacked element micro-optics block constructed of standard parts and optics. Additionally, exemplary micro-optic devices should be well suited for construction using techniques such as parallel assembly and testing, as well as automated wafer scale processes.

### BRIEF SUMMARY OF AN EXEMPLARY EMBODIMENT OF THE INVENTION

Exemplary embodiments of the invention are generally concerned with micro-optic devices, and associated processes, for use in optical multiplexing and/or demultiplexing applications. By way of example, a micro-optic wavelength division multiplexer/demultiplexer is provided for use in connection with an optical fiber configured to carry a bit stream comprising a plurality of data signals, each of which has a different characteristic wavelength.

In this exemplary implementation, the micro-optic wavelength division multiplexer/demultiplexer includes an optically neutral substrate having upper and lower surfaces, and a reflective coating disposed on a substantial portion of the lower surface. Additionally, an array of micro-prisms is disposed on the upper surface of the substrate. One of the micro-prisms is configured and arranged to output and/or receive multiplexed optical signals. The remaining micro-prisms are each constructed and arranged to transmit certain predetermined optical signal components and to reflect other predetermined optical signal components.

In an exemplary demultiplexing operation, one of the micro-prisms of the micro-optic wavelength division multiplexer/demultiplexer receives a multiplexed optical signal from an optical fiber or optical device. The multiplexed optical signal is passed to an array of succeeding micro-prisms, each micro-prism extracting a corresponding component of the input multiplexed optical signal and transmitting the extracted component, until only a single component remains. The single component is then transmitted by the last micro-prism in the array.

Multiplexing operations are performed as well with exemplary embodiments of the invention. In some exemplary cases, multiplexing of a plurality of optical data signals, each having a different characteristic wavelength, is performed with the micro-optic wavelength division multiplexer/demultiplexer using a process that is substantially the reverse of the exemplary optical demultiplexing process outlined above.

### BRIEF DESCRIPTION OF THE DRAWINGS

In order that the manner in which the above-recited and other aspects of the invention are obtained, a more particular description of the invention briefly described above will be rendered by reference to specific embodiments thereof which are illustrated in the appended drawings. Understanding that these drawings depict only exemplary embodiments of the invention and are not therefore to be considered limiting of its scope, the invention will be described and explained with additional specificity and detail through the use of the accompanying drawings in which:

FIG. 1 is a schematic drawing illustrating aspects of an exemplary operating environment for a micro-optic MUX/DEMUX;

FIG. 2 is a section view of an exemplary micro-optic MUX/EMUX implemented in a filter stack configuration;

FIG. 2A is a section view illustrating a portion of an exemplary micro-optic MUX/DEMUX implemented in a filter stack configuration that includes a fold mirror;

FIG. 3A is a top view of an exemplary micro-optic MUX/DEMUX illustrating an exemplary arrangement of a plurality of micro-prisms;

FIG. 3B is a section view taken from FIG. 3A and illustrating further details concerning the structure and arrangement of an array of micro-prisms;

FIG. 4 is a flow diagram illustrating aspects of an exemplary demultiplexing process;

FIG. 5 is a flow diagram illustrating aspects of an exemplary multiplexing process; and

FIG. 6 is a flow diagram illustrating aspects of an exemplary production process for a micro-optic device.

### DETAILED DESCRIPTION OF EXEMPLARY EMBODIMENTS OF THE INVENTION

I. Exemplary Operating Environments

In general, embodiments of the invention are concerned with the construction and use of micro-optic MUX/DEMUX (“MUX/IDEMUX”) devices suitable for use in connection with high speed optical data transmission systems conforming with various protocols. More particularly, exemplary embodiments of the invention are configured to implement optical wavelength division multiplexing (“WDM”) and/or demultiplexing of a plurality of optical data signals, which may also be referred to herein as optical bit streams, or simply bit streams.

As suggested by the foregoing, the MUX/DEMUX functionality implemented by exemplary embodiments of the invention is suitable for use in connection with, among other things, systems that employ multiple optical transmitters, such as lasers, each of which transmits an optical voice or data signal having a different characteristic wavelength. Such systems also typically include a plurality of detectors, or receivers, each of which receives an optical signal having a different characteristic wavelength.

At least some embodiments of the invention are suited for use in conjunction with a high speed communications system conforming to the Gigabit Ethernet (“GigE”) physical specification. However, the scope of the invention is not so limited and embodiments of the invention may be employed in any of a variety of high speed communications systems, examples of which include, but are not limited to, Gigabit Ethernet (“GigE”), 10 GigE (“XGig”), Fiber Distributed Data Interface (“FDDI”), Fibre Channel (“FC”), Synchronous Optical Network (“SONET”) and InfiniBand networks. One exemplary DWDM system wherein embodiments of the invention can be employed is configured to transmit as many as 128 OC-48 signals over a single fiber. More generally still, embodiments of the invention can be used in any compatible environment.

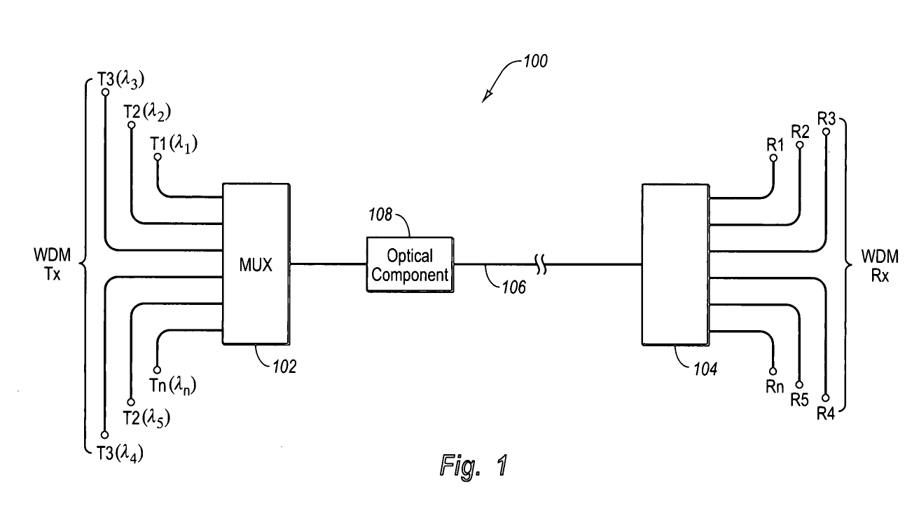

With specific reference now to FIG. 1, an exemplary implementation of a high speed communications system is indicated generally at 100. Exemplarily, the high speed communications system 100 involves the use of wavelength division multiplexing (“WDM”) and demultiplexing processes, such as dense wavelength division multiplexing (“DWDM”) and demultiplexing for example, but can be employed in connection with other wavelength division multiplexing and demultiplexing processes as well.

In the illustrated embodiment, the high speed communications system 100 includes a micro-optic device 102, exemplarily implemented as a micro-optic multiplexer or, alternatively, as a micro-optic multiplexer/demultiplexer. The micro-optic device 102 is configured to receive a plurality of input optical data signals of different optical wavelengths, each of which is transmitted by a corresponding optical transmitter, denoted as T₁ through Tₙ, and each of which corresponds to a “receive” channel of the micro-optic device 102. As suggested by the foregoing, the micro-optic device 102 implements wavelength division multiplexing of a plurality of input optical data signals, collectively denoted as Tₓ.

The high speed communications system 100 further includes a micro-optic device 104 exemplarily implemented as a micro-optic demultiplexer or, alternatively, as a micro-optic multiplexer/demultiplexer. The micro-optic device 104 communicates with, among other things, the micro-optic device 102 by way of an optical transmission medium 106, exemplarily, an optical fiber. In particular, the micro-optic device 104 is generally configured and arranged to receive a multiplexed optical signal from the micro-optic device 102 over the optical transmission medium 106 and then to extract one or more of the various discrete optical signals that collectively comprise the multiplexed signal received at the micro-optic device 104. As indicated in FIG. 1, the demultiplexed signals, collectively denoted at Rₓ, each correspond to a particular output channel of the micro-optic device 104. After demultiplexing has occurred, each of the component signals is then transmitted to a corresponding receiver, denoted at R₁ through Rₙ.

With continuing attention to FIG. 1, the high speed communications system 100 further includes one or more optical components 108 interposed in the transmission path between the micro-optic device 102 and the micro-optic device 104 and configured to pass a multiplexed optical data signal from the micro-optic device 102 to the micro-optic device 104. In one implementation, the optical component 108 comprises an erbium doped fiber amplifier (“EDFA”). However, embodiments of the invention are not constrained for use in connection with EDFAs but, more generally, may be employed in connection with a variety of other types of optical devices as well.

As an example, one or more optical components 108, comprising optical amplifiers, are employed in applications where the multiplexed optical data signal requires amplification in order to maintain its strength until arrival at a final destination, a such as receivers R₁ through Rₙ. In general, this is accomplished by amplifying the input multiplexed optical signal in the optical domain and then transmitting the amplified optical signal along the optical transmission medium 106 to the next optical amplifier, to the micro-optic device 104, or other component(s), as applicable.

With continuing reference to FIG. 1, it was noted above that embodiments of the invention can be used in connection with a variety of different optical transmission media 106 which, in general, can include any material, system, or device capable of passing or transmitting an optical signal. For example, in optical systems using a multiple transmitter arrangement such as that described above in connection with FIG. 1, the multiplexed bit stream is transmitted over an optical transmission medium 106 that comprises a single mode optical fiber (“SMF”).

Exemplary SMFs include an 8-10μ core disposed within a 125μ cladding, also collectively referred to as an “optical waveguide,” but embodiments of the invention can be employed with other types of SMFs, or other optical transmission media, as well. Typically, the cladding has a refractive index “n,” sometimes also referred to as “index of refraction,” that is lower, or “faster,” than that of the optical fiber, so as to ensure that transmitted optical signals remain substantially within the optical fiber core.

The expression SQRT(n₁²−n₂²), where n₁ is the refractive index of the core and n₂ is the refractive index of the cladding, is sometimes referred to as the numerical aperture (“NA”) of the fiber, an expression of the relative light gathering ability of that fiber. In general, fibers or other transmission media with a relatively high NA accept light well, while a fiber or transmission medium with a relatively low NA requires that the input light be highly directional. Embodiments of the invention are particularly well-suited for use in connection with relatively low NA optical fibers, however the scope of the invention is not limited to low NA fibers, nor to SMF fibers or any other particular type of fiber or transmission medium.

II. Exemplary 4 Channel MUX/DEMUX Micro-Optic Device

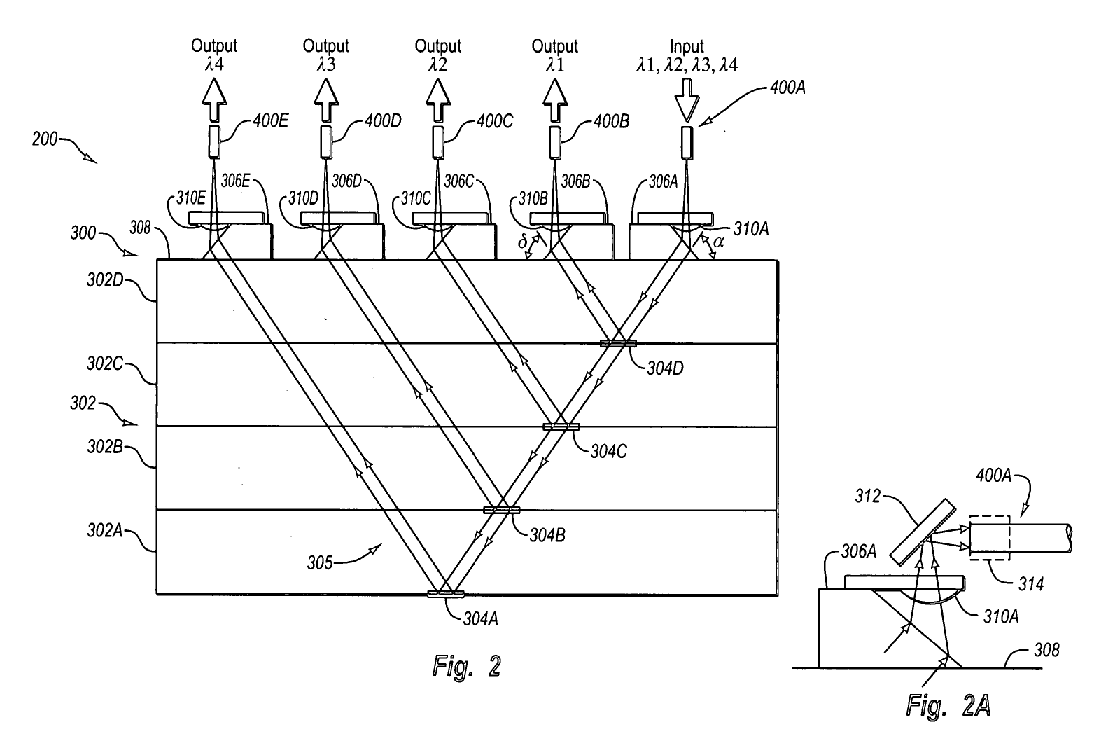

As suggested above, embodiments of the invention are suited for use in connection with the processing of bit streams that comprise a plurality of optical signals, each of which has a characteristic wavelength. Directing attention now to FIG. 2, details are provided concerning an exemplary optical system 200 that includes a micro-optic device 300, and an optical transmission medium 400A that is exemplarily implemented as an SMF, but which can take other forms and configurations as well. Various other optical transmission media 400B through 400E are provided as well.

In the illustrated exemplary embodiment, the micro-optic device 300 is arranged to receive optical signals from, and/or transmit optical signals to, the optical transmission media 400A through 400E, and is configured as a four channel MUX/DEMUX micro-optic device, that is, a micro-optic MUX/DEMUX device that is configured to multiplex up to four optical data signals into a bit stream, and/or to demultiplex bit streams comprising up to four different optical data signals. Of course, such a four channel configuration is exemplary only, and micro-optic MUX/DEMUX devices having any number “n” of channels may likewise be constructed and employed. Thus, the scope of the invention should not be construed to be limited to the exemplary micro-optic device configurations disclosed herein.

With more particular reference to FIG. 2, the exemplary illustrated embodiment of the micro-optic device 300 is configured for use in connection with, among other things, the demultiplexing of an input bit stream, received by way of the optical transmission medium 400A, that comprises four optical signals having, respectively, characteristic wavelengths λ₁, λ₂, λ₃ and λ₄. Accordingly, the illustrated implementation of the micro-optic device 300 includes a filter stack 302 having four individual filters 302A, 302B, 302C and 302D, respectively, stacked one on top of the other. The filters 302A, 302B, 302C and 302D can be constructed of glass, silicon, plastic, or any other material(s) compatible with the multiplexing and/or demultiplexing functionality of the micro-optic device 300.

Each of the filters 302A, 302B, 302C and 302D is at least partially coated on one surface with a filter coating having properties such that the filter coating is substantially reflective for one particular wavelength of light, or group of wavelengths, while being substantially nonreflective for other light of predetermined wavelengths. The filter coatings can comprise any material(s) suitable for implementing the functionality disclosed herein. Examples of suitable filter materials include metallic, non-metallic, and hybrid metallic/non-metallic coatings.

With particular reference to the illustrated embodiment, the filters 302A, 302B, 302C and 302D include, respectively, filter coatings 304A, 304B, 304C and 304D where, in this exemplary implementation, filter coating 304A reflects substantially only the optical signal of wavelength 4, filter coating 304B reflects substantially only the optical signal of wavelength λ₃, filter coating 304C reflects substantially only the optical signal of wavelength λ₂, and filter coating 304D reflects substantially only the optical signal of wavelength λ₁.

While a demultiplexing effect is indicated by the various directional light rays, denoted generally at 305, the illustrated device can additionally, or alternatively, operate in reverse. That is, the exemplary micro-optic device 300 is also effective in multiplexing multiple received optical signals having, respectively, characteristic wavelengths λ₁, λ₂, λ₃ and λ₄. Thus, the illustrated implementation should not be construed to limit the scope of the invention in any way. Further details concerning the operation of exemplary micro-optic devices are disclosed elsewhere herein.

In addition to the various filters and filter coatings, the exemplary micro-optic device 300 further includes a plurality of micro-prisms 306A through 306E mounted to the upper surface 308 of the filter stack 302. The micro-prisms 306A through 306E can comprise glass, silicon, or any other suitable material(s). In general, the micro-prisms are constructed and arranged, in the illustrated implementation, to direct the dispersed components of a collimated optical signal into the filter stack 302 at a particular entry angle α. Each micro-prism 306A through 306E is in optical communication, which could be direct or indirect optical communication depending upon the particular implementation, with the optical transmission medium 400A. Where the exemplary micro-optic device 300 implements both multiplexing and demultiplexing, the micro-prism 306A may be referred to as an input/output or “I/O” micro-prism..

It should be noted that the particular structural configuration and arrangement of the micro-prisms indicated in FIG. 2 are exemplary only. Accordingly, any other micro-prism configuration and/or arrangement of comparable functionality may alternatively be employed. More generally, optical components other than micro-prisms can alternatively be employed, consistent with the need to achieve a particular optical effect. Examples of such optical components include reflectors, refractors, and lenses.

With continuing attention to FIG. 2, each of the micro-prisms 306A through 306E supports a corresponding lens structure 310A through 310E, respectively. In the illustrated implementation, the lens structures 310A through 310E each comprise a collimating lens structure, but other types of lenses or optical components can also be employed, depending upon the optical effect(s) to be achieved. While lens structures 310A through 310E each have the same general configuration in this embodiment, the effects implemented by lens structure 310A as compared with lens structures 301B through 310D vary depending upon the process performed, as discussed in further detail below.

Exemplarily, lens structures employed in connection with this and other embodiments of the invention are substantially comprised of silicon, glass or other suitable materials and include an anti-reflective (“AR”) coating, substantially comprising metallic materials or other suitable material(s), disposed such that at least some of the light incident on the respective lens structures 310A through 310E is substantially unreflected by the lens structure upon which the light is incident. The particular light wavelength(s) that is/are to remain unreflected can vary from one application to another.

The lens structure 310A affixed to the input/output (“I/O”) micro-prism 306A is configured and arranged for optical communication with the optical transmission medium 400 so as to receive the multiplexed optical signal and to collimate the constituent components of the received multiplexed optical signal. The lens structure 310A then directs the components of the multiplexed optical signal into the micro-prism 306A which, in turn, redirects the optical components into the filter stack 302 at the entry angle α. As discussed below, the remaining four lens structures 310B through 310E are each configured and arranged, in at least some implementations, to pass a corresponding demultiplexed component of the received optical signal out of the filter stack 302, as disclosed in FIG. 2.

With continuing attention to FIG. 2, details are now provided concerning various operational aspects of the exemplary micro-optic device 300 disclosed there. In particular, a multiplexed bit stream comprising four data signals of characteristic wavelengths λ₁, λ₂, λ₃ and λ₄, respectively, is received from the optical transmission medium 400A and passed through the lens structure 310A and an I/O micro-prism 306A. In particular, the lens structure 310A collimates the four optical data signals carried in the bit stream so that they are substantially parallel with each other, and the associated I/O micro-prism 306A then redirects the collimated optical data signals into the filter stack at the entry angle α.

The four data signals of respective wavelengths λ₁, λ₂, λ₃ and λ₄, then pass through the first filter 302D, and then to the filter coating 304D corresponding to λ₁. As suggested above, the first filter coating(s) 304D comprises a coating stack that acts as a band pass or edge filter, which reflects wavelength λ₁ while the data signals of λ₂, λ₃ and λ₄ simply pass through the λ₁ filter coating 304D and into the second filter 302C of the filter stack 302. The reflected λ₁ data signal then passes upwards out of the first filter 302D, at an “exit angle” δ that, in this implementation, is substantially the same as the entry angle α.

It can be seen, from FIG. 2 for example, that the same filter coatings may be employed, regardless of whether the micro-optic device 300 is used for demultiplexing or multiplexing. By way of example, filter coating 304D would, in a multiplexing operation, reflect an incoming λ₁ data signal, but would transmit the incoming λ₂, λ₃ and λ₄ data signals that have been reflected by filter coatings 304C, 304B 304A, respectively.

After exiting the first filter 302D, the reflected optical data signal having wavelength λ₁ passes through the micro-prism 310B where it is redirected into the lens structure 310B which causes the light rays of the reflected optical data signal to converge. The resulting data signal is then launched into a suitable optical transmission medium 400B, such as an optical fiber for example. The demultiplexing of the incoming λ₂, λ₃ and λ₄ data signals of the incoming bit stream proceeds in a fashion analogous to that just described, as disclosed in FIG. 2.

As suggested earlier, the micro-optic device 300 is also configured, in the illustrated implementation, to multiplex incoming λ₁, λ₂, λ₃ and λ₄ data signals by a process substantially the reverse of that described above. More particularly, and as suggested in FIG. 2 for example, data signals having respective wavelengths λ₁, λ₂, λ₃ and λ₄ are received as inputs to the micro-optic device 300 are each reflected into the I/O micro-prism 306A and lens structure 310A. The resulting multiplexed bit stream is then launched into the optical transmission medium 400A. In the illustrated implementation, the multiplexed data stream is oriented substantially perpendicularly with respect to the upper surface 308 of the filter stack 302, however, the multiplexed data stream can be launched at other angles as well. As discussed below, various optical components and/or arrangements can be employed to achieve desired optical effects with respect to a multiplexed signal and/or with respect to individual optical signal components.

For example, in one alternative embodiment illustrated in FIG. 2A, a filter stack 302 configuration is indicated that is compatible with an optical fiber arrangement where one or more optical fibers, such as optical fiber 400A for example, are oriented parallel to the upper surface 308 of the filter stack 302, rather than perpendicularly as indicated in FIG. 2. Positioning and/or retention of the optical fiber(s) in this orientation may be achieved, for example, through the use of fiber V-grooves defined in the upper surface 308, or through the use of comparable structural features.

In the exemplary arrangement indicated in FIG. 2A, optical communication between the lens 310A and the optical fiber 400A is facilitated by the use of one or more fold mirrors 312. In general, the fold mirror 312 is configured and arranged to direct optical signals received from lens 310A into the optical fiber 400A, as well as to direct optical signals received from the optical fiber 400A into the lens 310A. The fold mirror 312 may comprise a single reflective element, as indicated in the exemplary configuration illustrated in FIG. 2A, or, alternatively, may comprise a plurality of reflective elements. More generally, the fold mirror, or fold mirrors, can be configured in any fashion that is suited to facilitate direction of one or more optical signals from one location to another.

It should be noted that various other devices and components may be substituted for the optical fiber 400A and/or the lens 310A that are optically connected by the exemplary fold mirror 312. Further, the same is likewise true with respect to one or more of the optical fibers 400B through 400E, and lenses 310B through 310D.

For example, some arrangements involve the use of a single or multiple lasers or detectors, all denoted generally at 314. Depending upon the implementation, the lasers and/or detectors may be mounted to the upper surface 308 of the filter stack 302, or elsewhere. In general, the use of lasers or detectors extends the functionality of the micro-optic device 300 such that the micro-optic device 300 operates as a multi-channel transmitter or a multi-channel receiver, as applicable. Moreover, combinations of micro-optic devices 300 configured in this way can be used to form parts of, or entire, communication systems.

In an arrangement where a laser 314 or other transmitter is provided, one or more fold mirrors 312 serve to direct an optical signal from the lasers 314 to the lenses 310A, or other optical devices. When lasers 314 or other transmitters are thus employed, multiple wavelengths from the laser 314 may be launched into a single fiber.

In another exemplary arrangement, where detectors 314 are provided, one or more fold mirrors 312 serve to direct optical signals from the lens 310A, or other optical devices, to the detectors 314. Thus, at least some arrangements that employ detectors 314 in this way enable receipt, at the detector, of multiple input wavelengths.

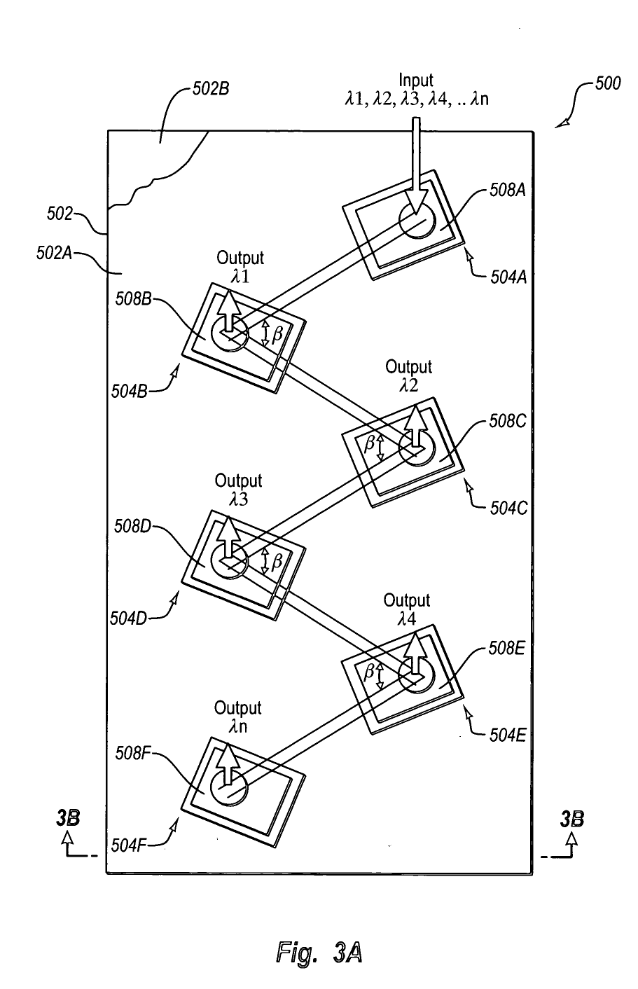

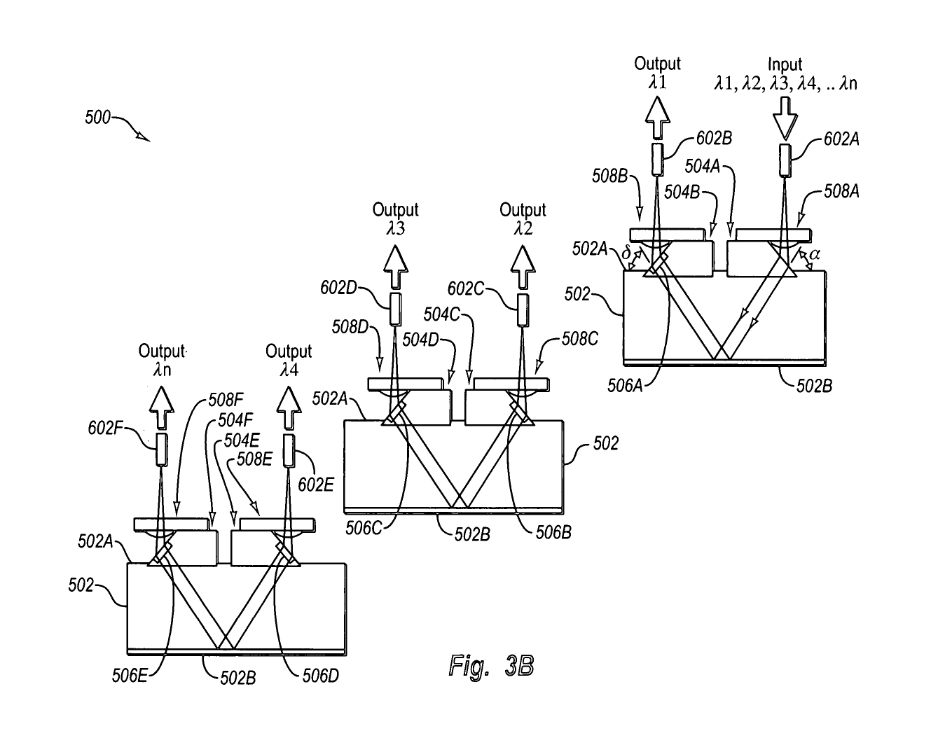

It should be noted that the foregoing discussion of fold mirrors, lasers and detectors is generally germane to other embodiments disclosed herein, and is not limited solely to the embodiment disclosed in FIG. 2. For example, one or more fold mirrors, lasers and/or detectors may also be comparably employed in connection with the exemplary embodiment illustrated in FIG. 3A. In one exemplary arrangement, one or more lasers and/or detectors are mounted to the upper surface 502A of the substrate 502 (FIG. 3A). In similar fashion, suitable fold mirrors are employed to facilitate communication between such lasers and detectors, and corresponding optical components such as lenses and optical fibers. As well, one or more optical fibers may be mounted to the upper surface 502A, or at least partially received within the substrate 502, as in the case where fiber V-grooves are defined by the substrate 502.

Thus, exemplary embodiments of the invention are able to readily demultiplex an incoming bit stream comprising a plurality of data signals of various wavelengths. Such embodiments are equally effective in multiplexing a plurality of data signals of varying wavelengths into a single bit stream suitable for transmission onto an optical fiber or other optical transmission medium. Further, use of embodiments of the invention in conjunction with low NA optical transmission fibers enables a high level of optical efficiency in the multiplexing and demultiplexing processes.

As is apparent from the above-described process and the disclosure herein, micro-optic devices can be constructed and employed to implement ADD/DROP functionalities where as few as one selected signal is multiplexed with, or extracted from, other multiplexed signals. Specifically, micro-optic devices may be constructed and employed that extract fewer than all of the optical components of an incoming multiplexed optical data signal.

In similar fashion, micro-optic devices can also be constructed and employed, consistent with the disclosure herein, which add one or more signals to a multiplexed signal. In this implementation, one or more filter coatings, as exemplified by filter coatings 304A through 304D for example (as well as 502B, and 506A through 506E, discussed below), are selected to reflect multiple wavelengths and/or to transmit multiple wavelengths, as circumstances dictate. Accordingly, the scope of the invention should not be construed to be limited to filter coatings that reflect and/or transmit any particular type or number of wavelengths. Rather, exemplary embodiments of the invention extend, more generally, to the use of discriminatory or selective filter coatings that are configured to reflect and/or transmit any of a variety of different optical wavelength combinations. As an example, the filtering of the wavelengths and redirecting them to the proper fiber, can also be used to achieve complete interleaver functionality.

Consistent with the foregoing, it should be noted that by varying aspects such as the composition, geometry, positioning, orientation and/or arrangement of one or more of the various components of the micro-optic device 300, and other embodiments disclosed herein, various desirable optical effects can be achieved. Accordingly, the scope of the invention is not limited solely to the exemplary embodiments disclosed herein.

III. Exemplary 5 Channel Micro-Optic MUX/DEMUX Device

The preceding discussion is largely concerned with aspects of an exemplary implementation of a four channel micro-optic MUX/DEMUX device implemented in the form of a filter stack. As noted elsewhere herein however, such a four channel implementation is exemplary only, and embodiments of the invention may, more generally, be implemented in various other multi-channel arrangements as well, where such multi-channel arrangements may comprise more, or fewer, than 4 channels. Moreover, implementations of the invention are not confined to filter stacks. Rather, any other arrangement of optical elements providing comparable functionality may likewise be employed. Aspects of one such alternative implementation are disclosed in FIGS. 3A and 3B, which are concerned with a multi-channel micro-optic device, denoted generally at 500 and configured to communicate with various input/output ooptical transmission media 602A through 602F.

In the embodiment disclosed in FIGS. 3A and 3B, the micro-optic device 500, exemplarily implemented as a multiplexer/demultiplexer, includes an optically neutral substrate 502 comprising glass, silicon or other suitable materials. On the upper surface 502A of the substrate 502 an array of six micro-prisms 504A through 504F are arranged in an angled or “tilted” configuration relative to each other, at a tilt angle β, so that optical signals can be reflected from one micro-prism to an adjacent micro-prism. Because micro-optic device 500 is implemented in this embodiment as a multiplexer/demultiplexer, micro-prism 504A comprises an I/O micro-prism that is configured to transmit, as well as receive, multiplexed optical signals.

As discussed in further detail below, the substrate 502 further includes a highly reflective coating 502B to facilitate reflection of optical signals between and among the six micro-prisms 504A through 504F. The reflective coating 502B may be metallic, non-metallic, or may comprise a hybrid metallic/non-metallic coating, where the reflectivity of the reflective coating 502B is selected to suit the particular application.

Similar to the embodiment of the micro-optic device disclosed in FIG. 2, the micro-optic device 500 employs a plurality of filter coatings, denoted at 506A through 506E respectively, each of which is substantially transmissive for one particular wavelength of light, or group of wavelengths, while being substantially reflective for other light of predetermined wavelengths. The filter coatings 506A through 506E, like the filter coatings disclosed herein in connection with FIG. 2, are exemplarily implemented as a thin film coating stack and can comprise any material(s) suitable for implementing the functionality disclosed herein. Examples of suitable filter materials include metallic, non-metallic, and hybrid metallic/non-metallic coatings. Note that the I/O micro-prism 504A does not include such a filter coating since, in this embodiment at least, the micro-prism 504A passes, or transmits, all received optical signals.

In the exemplary implementation illustrated in FIGS. 3A and 3B then, the filter coating 506A passes or transmits substantially only the optical signal of wavelength λ₁, filter coating 506B transmits substantially only the optical signal of wavelength λ₂, filter coating 506C transmits substantially only the optical signal of wavelength λ₃, and filter coating 506D transmits substantially only the optical signal of wavelength λ₄. Thus, this arrangement differs from that disclosed in FIG. 2 at least in that the filter coatings of FIG. 2 each reflect a single wavelength, and pass or transmit all other wavelengths while, in contrast, the filter coatings 506A through 506E of the embodiment illustrated in FIGS. 3A and 3B each pass or transmit a single wavelength, while reflecting all other wavelengths. As the foregoing illustrates, exemplary embodiments of the invention advantageously employ various optical components in a variety of different ways to achieve the multiplexing and/or demultiplexing of optical signals.

As further indicated in FIGS. 3A and 3B, the exemplary micro-optic device 500 also includes a plurality of lens structures 508A through 508E, each of which is supported by a respective micro-prism. Exemplarily, each lens structure 508A through 508E includes a collimating lens, but other lens structures can alternatively be employed, depending upon such considerations as the optical effect(s) desired to be achieved. Further, when the exemplary micro-optic device 500 is employed in demultiplexing processes such as are disclosed in FIGS. 3A and 3B, only the lens structure 508A performs a collimating function. The remaining lens structures perform a convergence function. Thus, it can be seen that where the exemplary micro-optic device 500 is employed in a multiplexing process, the respective functions of the lens structures 508A through 508E are substantially reversed.

With continuing attention to FIGS. 3A and 3B, details are now provided concerning certain operational aspects of the exemplary micro-optic device 500 disclosed. In particular, a multiplexed bit stream comprising five data signals, or optical components, of characteristic wavelengths λ₁, λ₂, λ₃, λ₄ and λ₅ respectively, passes through the input optical transmission medium 602A and is received at lens structure 508A and I/O micro-prism 504A.

As noted elsewhere herein, the lens structure 508A and I/O micro-prism 504A are arranged so that the multiplexed bit stream is first collimated by the lens structure 508A. The collimated optical components of the multiplexed bit stream then pass through the I/O micro-prism 504A and are redirected by the I/O micro-prism 504A downward into the substrate 502 upon which the micro-prisms 504A through 504F reside. The reflective coating 502B at the bottom of the substrate 502 then reflects the bit stream upward to the λ₁ micro-prism 504B where the filter coating permits the λ₁ data signal to pass out of the micro-prism 504B, but reflects the remaining λ₂, λ₃, λ₄ and λ₅ data signals of the bit stream back down into the filter element 502 to the reflective coating 502B which, in turn, reflects the remaining λ₂, λ₃, λ₄ and λ₅ data signals into the next micro-prism in the array. The λ₁ data signal then passes through the collimating lens of the lens structure 508B and exits the micro-optic MUX/DEMUX device as an output optical signal having a wavelength λ₁. As best illustrated in FIG. 3B, the output optical signal of wavelength λ₁ is then, exemplarily, launched into optical transmission medium 602B, which may comprise, for example, an SMF.

This process is largely repeated for each of the remaining multiplexed data signals having respective wavelengths λ₂, λ₃, λ₄ and λ₅, so that an output signal passes out of each succeeding micro-prism 504C through 504F. Thus, the configuration and arrangement of the micro-prisms 504A through 504F relative to each other, in cooperation with the reflective coating 502B of the substrate 502 and the various filter coatings 506A through 506E, enables this exemplary embodiment of the invention to manipulate and direct an incoming multiplexed bit stream so that one or more output signals of characteristic wavelength can be extracted from the bit stream at each respective micro-prism 504B through 504F.

As suggested by the various exemplary implementations of micro-optic MUX/DEMUX devices disclosed herein, aspects of embodiments of the invention can be readily tailored to suit a variety of operating requirements and environments. By way of example, aspects such as, but not limited to, the composition, geometry, positioning, orientation and/or arrangement of one or more of the various components of the micro-optic device 500, various desirable optical effects can be achieved. Accordingly, the scope of the invention is not limited solely to the exemplary embodiments disclosed herein.

IV. Exemplary Demultiplexing Process

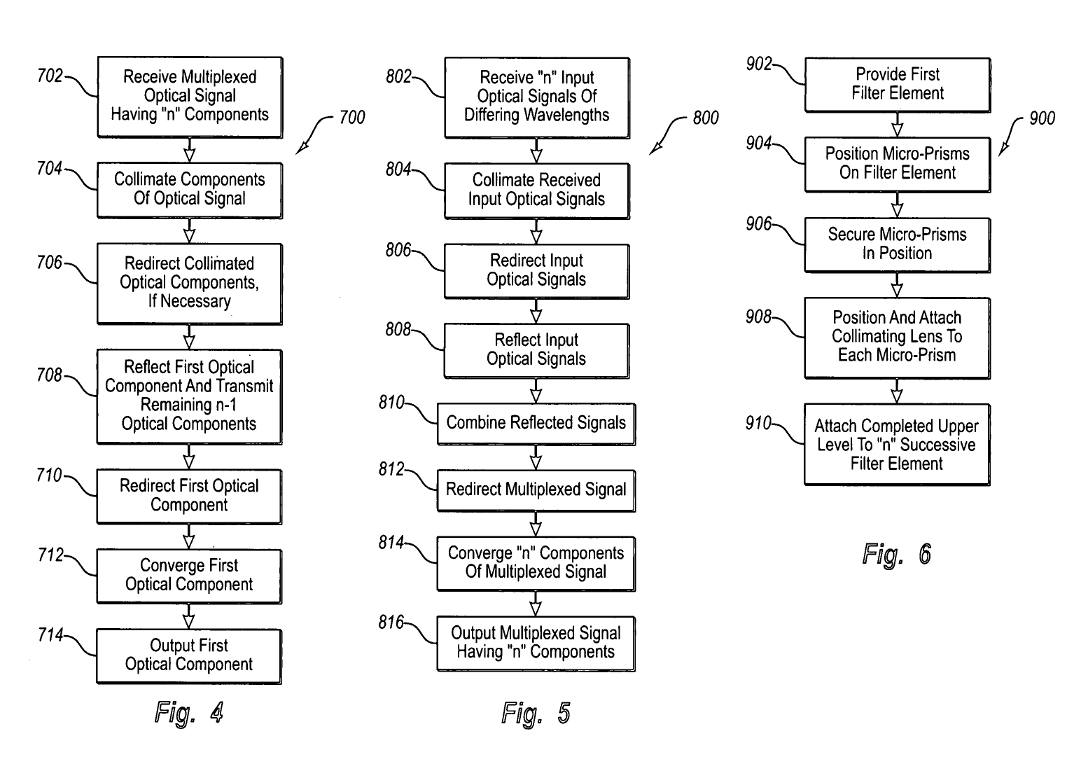

With attention now to FIG. 4, details are provided concerning aspects of an exemplary demultiplexing process denoted generally at 700. At stage 702 of the process 700, a multiplexed optical data signal having “n” optical components is received. Each of the “n” optical components has a corresponding wavelength that is different from that of the other optical components. At stage 704 of the process 700, the “n” optical components are collimated and, at stage 706, the collimated optical components of the multiplexed optical signal are redirected, if necessary.

The process 700 then moves on to stage 708 where the first component of the optical data signal is reflected, and the remaining n-1 optical components are transmitted. In one alternative of stage 708, the first component of the optical data signal is transmitted, and the remaining n-1 optical components are reflected. The process 700 then advances to stage 710 where the first optical signal that has been reflected is redirected.

Next, the process 700 advances to stage 712 where the light rays of the first optical component are caused to converge with each other. At stage 714, the first optical component is then output, such as to an optical fiber or other optical transmission medium. The process 700 then continues substantially in the fashion outlined above until all “n” components of the input multiplexed signal have been reflected and transmitted as output signals. Note however, that the process 700 can be stopped at one or more selected points, such that fewer than “n” optical components, and as few as one optical component, are extracted, or dropped, from the initially received multiplexed signal. Moreover, the order in which the optical components are extracted from the multiplexed signal can be varied as necessary.

Further, while FIG. 4 suggests that the extraction of the various optical components of the input multiplexed signal occurs in serial fashion, the scope of the invention is not so limited. Rather, in at least some embodiments of the process 700, extraction of each of the various optical components of the input multiplexed signal occurs substantially simultaneously with extraction of the other optical components. Thus, aspects of the exemplary process 700 may be varied as necessary to suit the requirements of a particular application.

V. Exemplary Multiplexin Process

Directing attention next to FIG. 5, details are provided concerning aspects of an exemplary multiplexing process denoted generally at 800. At stage 802 of the process 800, “n” input signals, each having a different respective wavelength, are received. The “n” input signals may be received substantially simultaneously, or in some particular order.

The process 800 then advances to stage 804 where each of the “n” input signals is individually collimated. At stage 806 of the process 800, each of the “n” collimated input signals is individually redirected and, at stage 808, individually reflected. The “n” reflected input signals are then combined together, or multiplexed, at stage 810. The multiplexed signal is then redirected at stage 812 and converged at stage 814. Finally, the multiplexed signal is output at stage 816.

It should be noted with reference at least to stages 804 through 808 of the process 800 that the processes performed at each of those stages are typically performed substantially simultaneously for each of the “n” input signals. For example, at stage 808, all of the “n” input signals are reflected at substantially the same time.

Of course, any number of variations of the process 800 can be implemented. In one case, fewer than “n” optical components are multiplexed together. More particularly, at an alternative to stage 808, n-x signals are reflected, where “x” can be any desired value that is less than “n.” Moreover, one or more of the “n” input signals may comprise a multiplexed signal, such that the process 800 operates to add one or more signals to the input multiplexed signal to produce a new multiplexed signal that is then output.

VI. Exemplary Micro-Optic MUX/DEMUX Construction Processes

It is often desirable to be able to actively align the various components of the micro-optic MUX/DEMUX during the manufacturing process. Moreover, the structure of at least some exemplary implementations of the micro-optic MUX/DEMUX is well suited for production techniques such as parallel assembly and testing, as well as automated wafer scale processes.

Directing attention finally to FIG. 6, details are provided concerning an exemplary process 900 for constructing a micro-optic MUX/DEMUX. In general, the process 900 represents a “planar geometry” approach to construction and results in the production of a filter stack implementation of a micro-optic MUX/DEMUX, one embodiment of which is disclosed in FIG. 2.

At stage 902 of the process, a first filter element is provided. A plurality of micro-prisms are then positioned on an upper surface of the first filter element at stage 904. The process 900 next advances to stage 906 where each of the micro-prisms is secured in a desired position and orientation using, for example, a laser soldering or die bonding process. At stage 908 of the process, a collimating lens or other optical device(s) is/are positioned on, and attached to, each of the micro-prisms. Stage 908, similar to stage 906, can be implemented, for example, by laser soldering or die bonding processes.

Thus, the upper level of the micro-optic MUX/DEMUX device is complete, and the remainder of the production process simply involves attaching, at stage 910, this completed upper level to “n” successive filter elements, where the number “n” of filter elements is determined with reference to the number of channels of the multiplexed signal to be processed. The attachment of the succeeding filter elements can be implemented by processes such as laser soldering, die bonding, or any other suitable process.

Of course, various alternatives to the process 900 can be implemented. In one such alternative, each of the collimating lenses of the micro-optic device is actively aligned with a corresponding fiber. In this alternative to stage 908, a die bonding machine is used to manipulate the collimating lenses over the corresponding micro-prisms. After this active alignment is completed, the micro-prisms and collimating lenses are then secured into position as a single unit, such as by laser soldering or other suitable process(es). It should be noted that processes employing this alternative to stage 908 are also useful in the construction of embodiments of the invention where a plurality of micro-prisms and associated collimating lenses are disposed on an upper surface, actively aligned, and secured in position on the single substrate in a parallel fashion, such as in the case of the exemplary five channel micro-optic MUX/DEMUX devices disclosed herein.

With respect to the exemplary process 900, and comparable production processes, the use of standard parts in the construction of the micro-optic MUX/DEMUX devices facilitates manufacturing processes and reduces the overall cost associated with embodiments of the invention. The reduction of costs and ease of manufacturing of embodiments of the invention are further advanced through the use of automated wafer level assembly, testing and other similar processes and techniques.

The disclosed embodiments are to be considered in all respects only as exemplary and not restrictive. The scope of the invention is, therefore, indicated by the appended claims rather than by the foregoing disclosure. All changes which come within the meaning and range of equivalency of the claims are to be embraced within their scope.

1. A micro-optic device, comprising:
a substrate having upper and lower surfaces, and a reflective coating disposed on a portion of the lower surface;
an array of micro-prisms attached to the upper surface of the substrate in a predetermined arrangement with respect to each other, at least one of the micro-prisms comprising an I/O micro-prism, and all but the I/O micro-prism including a surface having a filter coating able to transmit at least one corresponding optical wavelength, the at least one corresponding optical wavelength being different for each filter coating; and
a plurality of collimating lenses, each of the plurality of collimating lenses being at least indirectly attached to a corresponding micro-prism and cooperating with the filter coated surface of the corresponding micro-prism to at least partially define an optical path.

2. The micro-optic device as recited in claim 1, wherein the micro-optic device comprises at least one of: a multiplexer; and, a demultiplexer.

3. The micro-optic device as recited in claim 1, wherein the substrate comprises a substantially optically neutral material.

4. The micro-optic device as recited in claim 1, wherein the reflective coating of the substrate substantially comprises one of: a metallic coating; a non-metallic coating; a hybrid metallic/non-metallic coating.

5. The micro-optic device as recited in claim 1, wherein the I/O micro-prism is configured to redirect a received multiplexed optical signal.

6. The micro-optic device as recited in claim 1, wherein each filter coating is able to reflect substantially all optical wavelengths except the at least one optical wavelength that is transmissible by the filter coating.

7. The micro-optic device as recited in claim 1, wherein the array of micro-prisms is arranged such that each micro-prism cooperates with at least one adjacent micro-prism to define a tilt angle β.

8. The micro-optic device as recited in claim 1, wherein the array of micro-prisms is arranged such that at least a portion of an optical signal received at the I/O micro-prism is directed to one or more succeeding micro-prisms.

9. The micro-optic device as recited in claim 1, wherein each micro-prism is arranged to receive an optical signal reflected by the reflective coating disposed on the lower surface of the substrate.

10. The micro-optic device as recited in claim 1, wherein each micro-prism is configured to redirect a received optical signal.

11. The micro-optic device as recited in claim 1, wherein the filter coated surface of each micro-prism is disposed at a predetermined angle relative to the lower surface of the substrate.

12. The micro-optic device as recited in claim 1, wherein the plurality of collimating lenses are arranged in substantially the same plane.

13. The micro-optic device as recited in claim 12, wherein the plane is substantially parallel to the lower surface of the substrate.

14. The micro-optic device as recited in claim 1, wherein each collimating lens is arranged, relative to the respective micro-prism to which it is attached, such that:
a collimated optical signal exiting the collimating lens is redirected by the micro-prism; and
a redirected optical signal exiting the micro-prism is converged by the collimating lens.

15. The micro-optic device as recited in claim 1, further comprising:
a fold mirror; and
an optical component arranged such that the fold mirror facilitates optical communication between the optical component and one of the lenses.

16. The micro optic device as recited in claim 15, wherein the optical component comprises at least one of: an optical detector; and, an optical transmitter.

17. The micro optic device as recited in claim 15, wherein the optical component is mounted to the upper surface of the substrate.

18. The micro-optic device as recited in claim 1, further comprising an optical fiber mounted proximate the upper surface of the substrate and configured for at least indirect optical communication with a micro-prism.

19. A micro-optic device, comprising:
a plurality of filter elements arranged in a stack, each of the filter elements including a surface upon which is disposed a respective filter coating that is able to reflect at least one corresponding optical wavelength, the at least one corresponding optical wavelength being different for each filter coating;
an array of micro-prisms attached to an upper surface of the filter stack, at least one of the micro-prisms comprising an I/O micro-prism, and each of the micro-prisms arranged for optical communication with a corresponding filter coating; and
a plurality of collimating lenses, each of the plurality of collimating lenses being at least indirectly attached to a corresponding micro-prism and cooperating with the corresponding micro-prism to at least partially define an optical path.

20. The micro-optic device as recited in claim 19, wherein the micro-optic device comprises at least one of: a multiplexer; and, a demultiplexer.

21. The micro-optic device as recited in claim 19, wherein each of the filter coatings substantially comprises one of: a metallic coating; a non-metallic coating; a hybrid metallic/non-metallic coating.

22. The micro-optic device as recited in claim 19, wherein the I/O micro-prism is configured to redirect a received multiplexed optical signal.

23. The micro-optic device as recited in claim 19, wherein each filter coating is able to transmit substantially all optical wavelengths except the at least one optical wavelength that is reflected by the filter coating.

24. The micro-optic device as recited in claim 19, wherein the array of micro-prisms is arranged such that at least a portion of an optical signal received at the I/O micro-prism is directed to one or more succeeding micro-prisms.

25. The micro-optic device as recited in claim 19, wherein each micro-prism is arranged to receive an optical signal reflected by a corresponding filter coating.

26. The micro-optic device as recited in claim 19, wherein each micro-prism is configured to redirect a received optical signal.

27. The micro-optic device as recited in claim 19, wherein each collimating lens is arranged, relative to the respective micro-prism to which it is attached, such that:
a collimated optical signal exiting the collimating lens is redirected by the micro-prism; and
a redirected optical signal exiting the micro-prism is converged by the collimating lens.

28. The micro-optic device as recited in claim 19, further comprising:
a fold mirror; and
an optical component arranged such that the fold mirror facilitates optical communication between the optical component and one of the lenses.

29. The micro optic device as recited in claim 28, wherein the optical component comprises at least one of: an optical detector; and, an optical transmitter.

30. The micro optic device as recited in claim 28, wherein the optical component is mounted to the upper surface of the substrate.

31. The micro-optic device as recited in claim 19, further comprising an optical fiber mounted proximate the upper surface of the substrate and configured for at least indirect optical communication with a micro-prism.

32. In an optical device, a method for demultiplexing optical signals, the method comprising:
receiving an optical signal having “n” components, each of the components having a different wavelength;
reflecting at least a first component of the optical signal, and transmitting remaining components of the optical signal;
redirecting at least the first component of the received optical signal;
converging at least the first component of the received optical signal; and
outputting at least the first component of the received optical signal.

33. The method as recited in claim 32, further comprising repeating the reflecting, transmitting, redirecting, converging and outputting processes until each of “n” components have been output.

34. The method as recited in claim 32, further comprising collimating the received optical signal.

35. The method as recited in claim 32, further comprising redirecting the received optical signal.

36. The method as recited in claim 32, further comprising reflecting the output first component of the received optical signal.

37. In an optical device, a method for demultiplexing optical signals, the method comprising:
receiving an optical signal having “n” components, each of the components having a different wavelength;
reflecting the received optical signal;
transmittingat least a first component of the optical signal, and reflecting remaining components of the optical signal;
redirecting at least the first component of the received optical signal;
converging at least the first component of the received optical signal; and
outputting at least the first component of the received optical signal.

38. The method as recited in claim 37, further comprising repeating the reflecting, transmitting, redirecting, converging and outputting of optical signal components until each of the “n” components have been output.

39. The method as recited in claim 37, further comprising collimating the received optical signal.

40. The method as recited in claim 37, further comprising redirecting the received optical signal.

41. The method as recited in claim 37, further comprising reflecting the output first component of the received optical signal.

42. In an optical device, a method for multiplexing optical signal components, the method comprising:
receiving “n” optical signal components, where “n” is equal to or greater than one, each of the optical signal components having a different wavelength;
collimating each optical signal component;
redirecting each optical signal component;
reflecting each optical signal component;
combining the optical signal components to form a multiplexed optical signal having “n” optical components; and
outputting the multiplexed optical signal.

43. The method as recited in claim 42, further comprising redirecting the multiplexed optical signal.

44. The method as recited in claim 42, further comprising converging the optical signal components of the multiplexed optical signal.

45. The method as recited in claim 42, further comprising reflecting the multiplexed optical signal after the multiplexed signal has been output.
